(19) United States
(12) Patent Application Publication
(10) Pub. No.: US 2015/0272809 A1
(43) Pub. Date: Oct. 1, 2015

(54) ROBOTIC DEVICE FOR ASSISTANCE AND REHABILITATION OF LOWER LIMBS

(71) Applicant: UNIVERSITÀ CAMPUS BIO-MEDICO DI ROMA, Rome (IT)

(72) Inventors: Dino Accoto, Andrano (IT); Fabrizio Sergi, Houston, TX (US); Giorgio Carpino, Naples (IT); Nevio Luigi Tagliamonte, Pagani (IT); Simone Galzerano, Salerno (IT); Michelangelo Di Palo, Pisa (IT); Eugenio Guglielmelli, Rome (IT)

(21) Appl. No.: 14/434,124

(22) PCT Filed: Oct. 7, 2013
(86) PCT No.: PCT/IB2013/059174

§ 371 Date: Apr. 8, 2015

(30) Foreign Application Priority Data
Oct. 9, 2012 (IT) RM2012A000482

(51) Int. Cl. A61H 3/00

(52) U.S. Cl. CPC A61H 3/00; A61H 2003/007

(57) ABSTRACT

The present invention refers to a robotic device for assistance and rehabilitation of lower limbs, in particular, an exoskeleton for supporting the walking of a human being.

The present invention refers to a robotic device for assistance and rehabilitation of lower limbs.

In particular, the device constitutes an exoskeleton supporting the walking of a human being.

Exoskeletons are wearable robotic structures able to:
assist motions;
administer rehabilitative therapies;
increase motor skills;
record information of kinematic and dynamic nature related to the walking of a user, so to allow a subsequent evaluation of a subject's performances.

Exoskeletons for lower limbs may be:
portable devices useful in structured and non-structured environments;
treadmill-associated stationary systems.

Portable exoskeletons are used, e.g., to restore walking in paraplegic subjects or assist subjects with reduced motor skills. In the military field they are used to assist soldiers in carrying loads, or in long walks.

Non-portable exoskeletons are used essentially in the medical field, mainly for rehabilitative purposes, on patients that, because of traumas or physiological decay of motor performances, need to rehabilitate their motor skills. In the same field, exoskeletons can be used to record subject's movements, e.g. to quantitatively and objectively evaluate the effectiveness of certain rehabilitative protocols.

The vast majority of robotic systems used to assist locomotion have a kinematic structure of anthropomorphic type: the axes of robotic joints, apart from small alignment errors, match those of human articulations.

The main drawback of anthropomorphic systems is represented by the need to align the axes of the robotic joints with those of human articulations, so as to prevent that i) the robot may apply forces potentially harmful to articulations and ii) excessive scraping of cuffs on the subject's skin may occur. As a result, mounting an anthropomorphic exoskeleton on the subject's legs requires a lengthy preliminary stage in which attempts are made to minimize the coaxiality error between robotic joints and human articulations.

Moreover, in most existing systems, robot actuators are placed on the structure co-located with the joints to be actuated, with the entailed increase of inertial actions associated with the swinging of additional masses, especially during the leg raising and advancing stages (swing phase). The scientific literature offers numerous examples of wearable robotic systems for assistance to walking, intended for applications such as: enhancement of motor performances, (neuro-)rehabilitation, aid to daily life activities.

Such devices may be grouped into two main categories:
Autonomous robotic systems;
Treadmill-based robotic systems.

Autonomous robotic systems can be used in a non-structured environment, as the mechanical structure and the power supply and control system are sufficiently compact and light-weight to be carried by the wearer.

In the literature examples of autonomous systems are reported, which are used for:
Enhancement of healthy subjects' performances (typically for transport of high masses), both in the civil and the military field;
Aid to subjects with motor disabilities, often due to spinal cord injuries.

Stationary systems resorting to treadmills normally comprise a robot weight-balancing system. Such systems, requiring the subject to walk on a treadmill, are typically employed in rehabilitation, e.g. for neuro-rehabilitation of post-stroke subjects.

Stationary devices described in the scientific literature are composed of an essentially anthropomorphic kinematic structure.

Apart from specific solutions adopted for actuation systems (linear, rotary actuators, etc.) and drive systems (belts, cables, etc.), state-of-the-art devices have actuated rotary joints aligned with body joints (i.e., hip, knee and ankle articulations) and links (more generally, segments interconnecting joints) essentially parallel to body segments (thigh, leg, foot).

A further common feature of the mentioned devices is the nearly even distribution of the mechanical structure along the human limbs. The actuators are often located directly at the joint of interest (hip, knee and ankle), or, alternatively, are positioned on the mechanical structure parallel to the human limbs, along with suitable systems which transmit motion to actuated joints. Both solutions cause the localization of high masses and inertias not only at proximal body districts (trunk, thigh), but also at distal districts (leg, foot). Such a condition implies for the user the need to deliver high torques/forces during the swing phase.

Ultimately, in the state of the art there are no robotic devices for assistance of lower limbs that:
have a non-anthropomorphic kinematic structure, with a number of joints (actuated and non-actuated) and a number of links greater than that strictly necessary to replicate the kinematic structure of the human leg; and actuated rotary joints not aligned to the human ones;
distribute mechanical parts unevenly along the limb so as to minimize mass and inertia in the distal districts, i.e., which swing during the swing phase.

Therefore, the aim of the present invention is to overcome the problems set forth hereto, and this is attained by means of a robotic device as defined by claim 1.

Hence, the technical problem solved by the present invention consists in ensuring a better kinematic compatibility between lower limbs and wearable robot, by enhancing system ergonomics and wearability. This is made possible by the non-anthropomorphic nature of the kinematic structure of the robot. Moreover, the robot allows an easy adaptability to users with different anthropometric sizes. The greater freedom in arranging the actuators on the robotic structure enables a reduction of inertial effects associated to the motion of swinging masses. The present invention, by overcoming the problems of the known art, entails several evident advantages.

In particular, the non-anthropomorphic kinematic structure has the potential of ensuring greater kinematic compatibility between robot and human body, remarkably enhancing system ergonomics. This is possible because the constraint of (robot and human) joint axes alignment is removed, and the structure proves to be intrinsically able to compensate for unavoidable micro-errors occurring during the device wearing stage.

Moreover, the possibility of placing the actuators not necessarily at the joints, but also at a position proximal to the trunk and pelvis, reduces the swinging masses and the consequent inertial effects. The solution proposed with the present invention ensures instead greater kinematic compatibility, preventing macro- and micro-misalignments and remarkably enhancing system ergonomics.

The presence of passive links, i.e. constrained at the ends by hinges, essentially perpendicular to the body segments or limb axis, ensures a simpler and quicker wearability of the device, ensures that the interaction forces be essentially perpendicular to the body segments or limb axis, thereby minimizing parallel forces, ineffective to the ends of motion generation and cause of potential discomfort for the user. The same passive links, by being able to freely rotate about the hinges constraining them at their ends, also allow to make the robot intrinsically adaptable to users of different build.

The possibility of manually varying the lengths and tilt of the links and the position of the passive joints of the robot ensures the use of the device for an ample number of users with different anthropometric sizes.

Moreover, the possibility of placing the actuators at any one point of the robot (even remotely) ensures a remarkable flexibility in the design phase; by placing the actuators in a proximal position at the level of the pelvis, the inertia perceived by the user during walking, due to masses placed in a position distal to the hip, decreases sensibly.

These and other advantages, along with the features and the modes of employ of the present invention, will be made apparent in the following detailed description of preferred embodiments thereof, which is given by way of example and not for limitative purposes. Reference will be made to the figures of the annexed drawings, wherein:

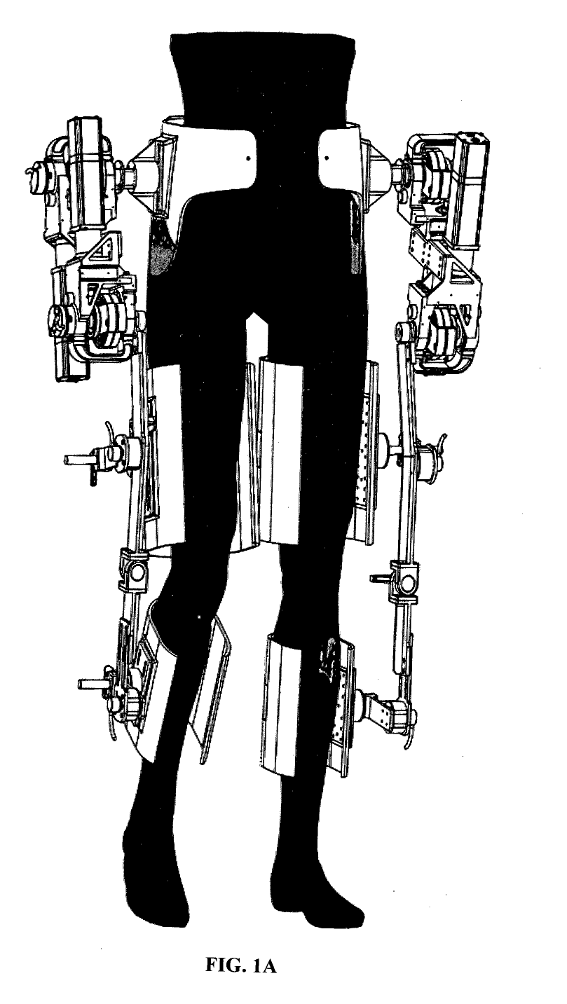

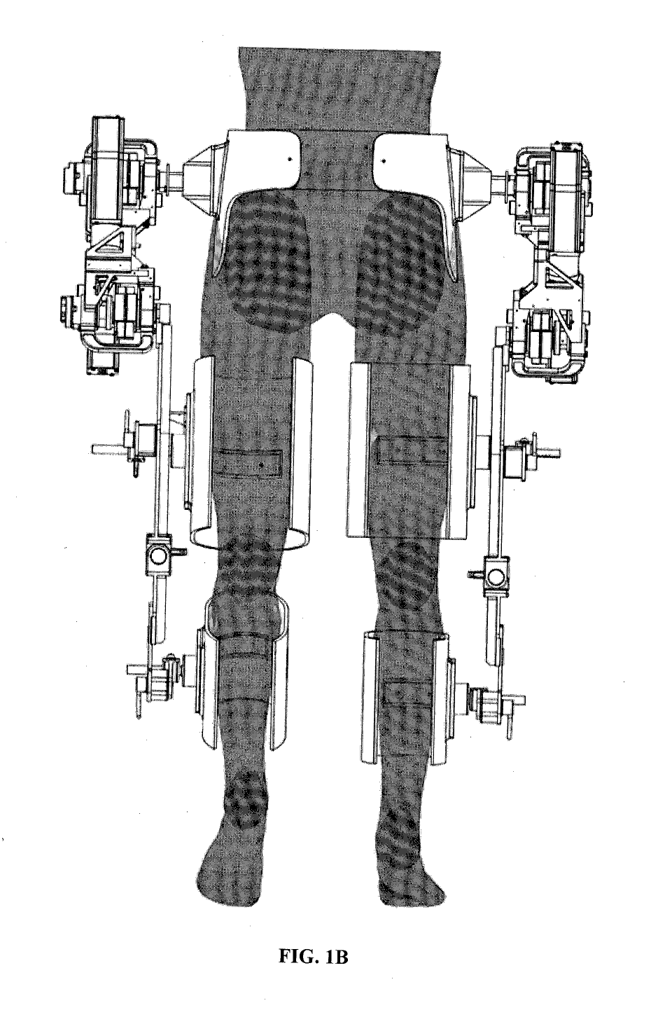

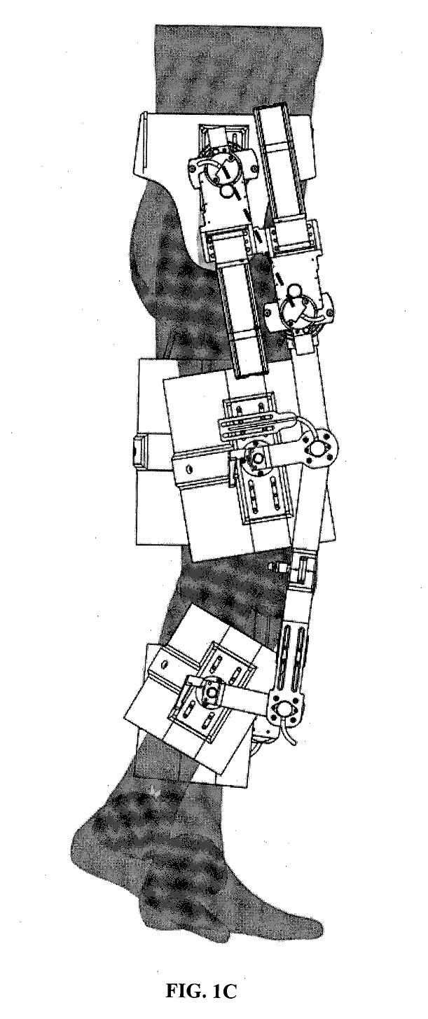

FIGS. 1A, 1B, 1C are respectively perspective, front and side views of a device according to the present invention;

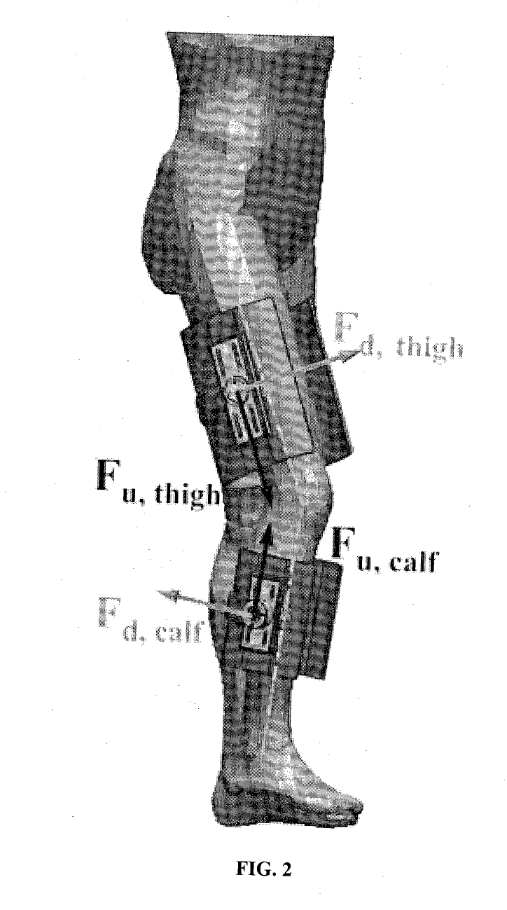

FIG. 2 is a depiction of forces acting on body segments of a subject wearing a device according to the present invention;

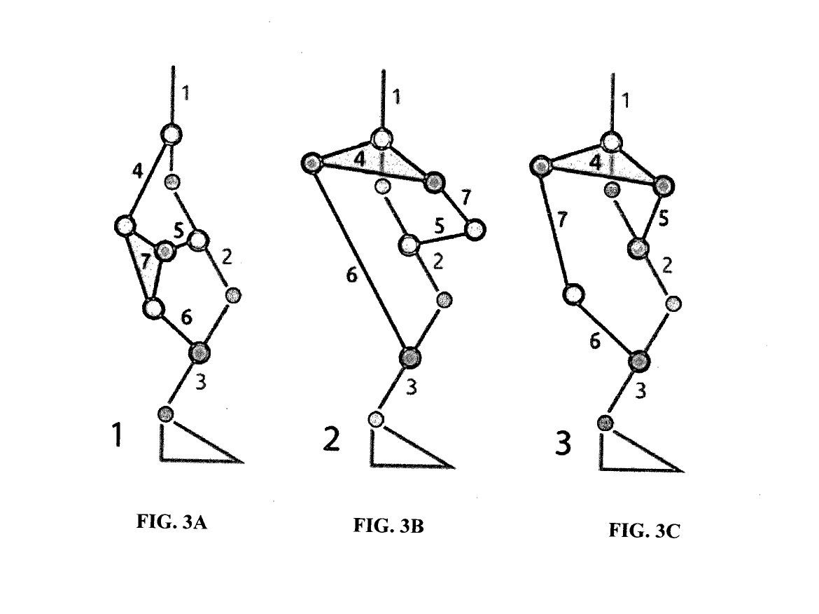

FIGS. 3A, 3B, 3C are morphological depictions of selected topologies for the realization of the device according to the present invention;

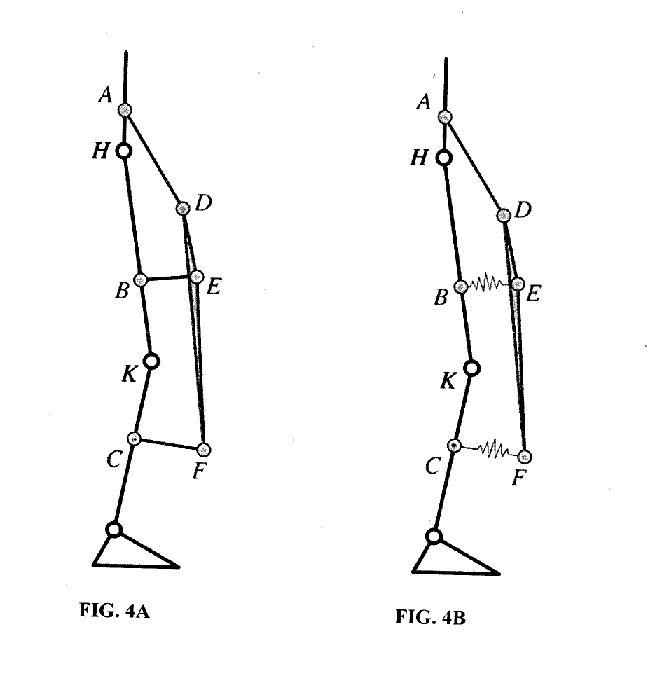

FIGS. 4A, 4B are schematic depictions of possible kinematic chains adoptable in the device according to the present invention;

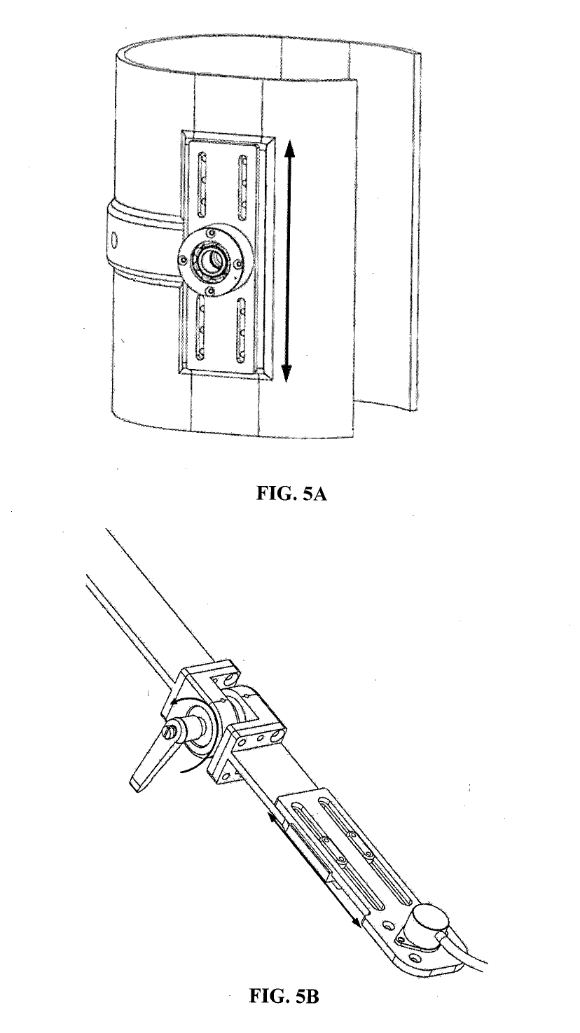

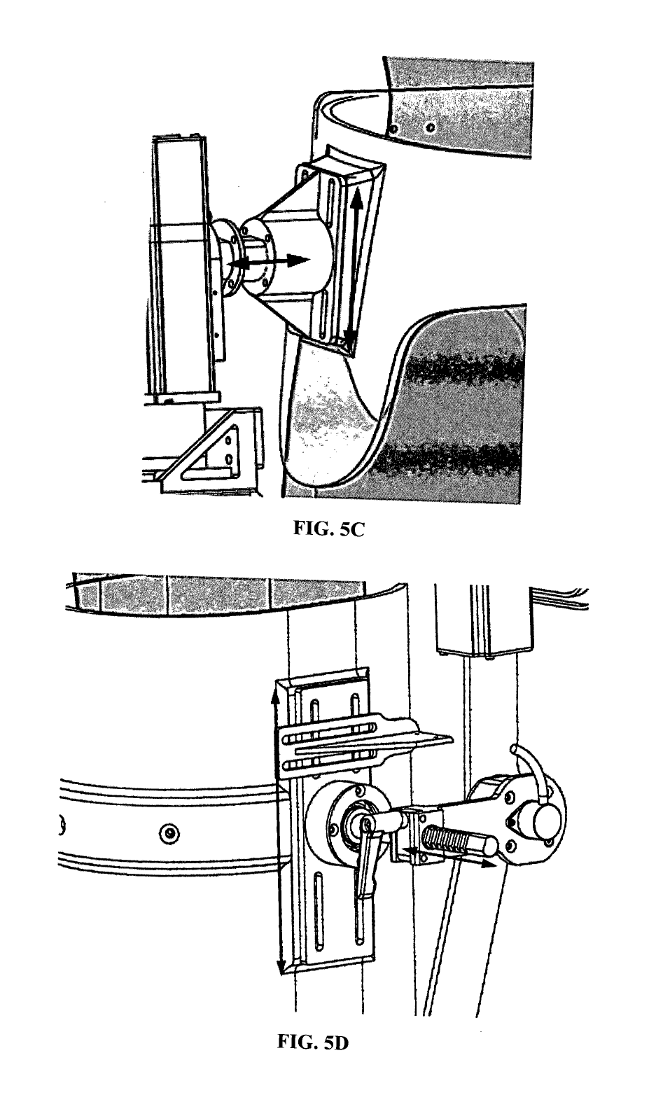

FIGS. 5A to 5D are details illustrating some of the adjusting mechanisms present in the device according to the present invention;

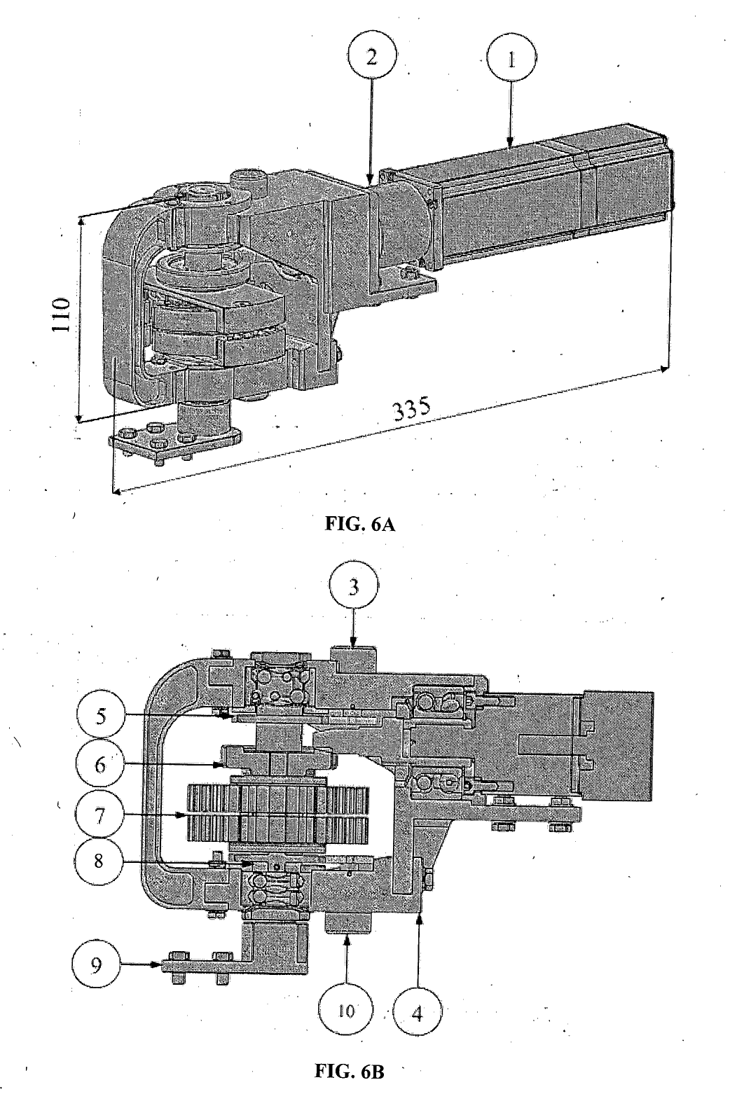

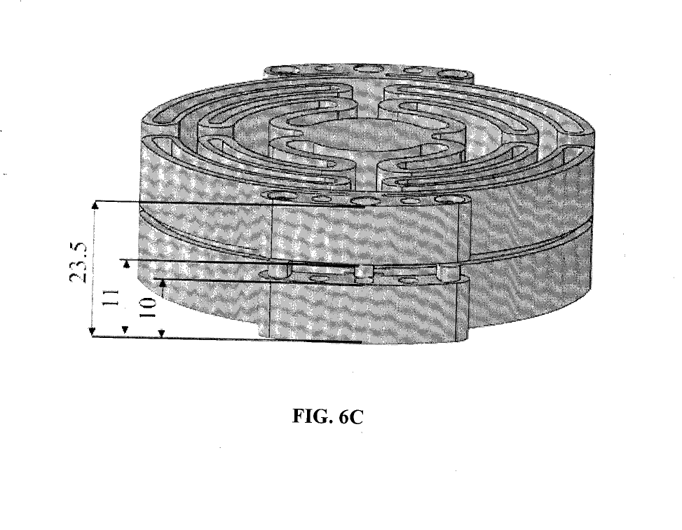

FIGS. 6A to 6C are views of a possible actuator for the device according to the present invention; and

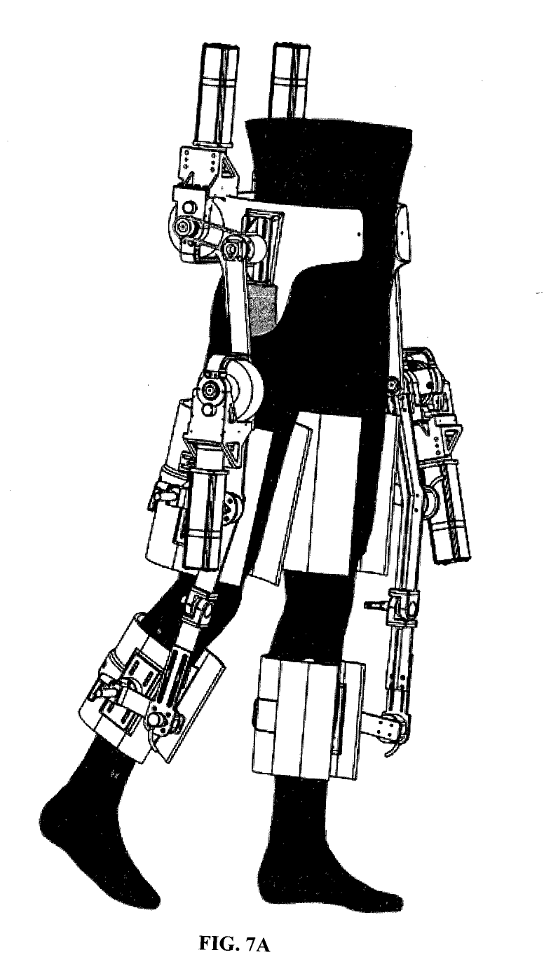

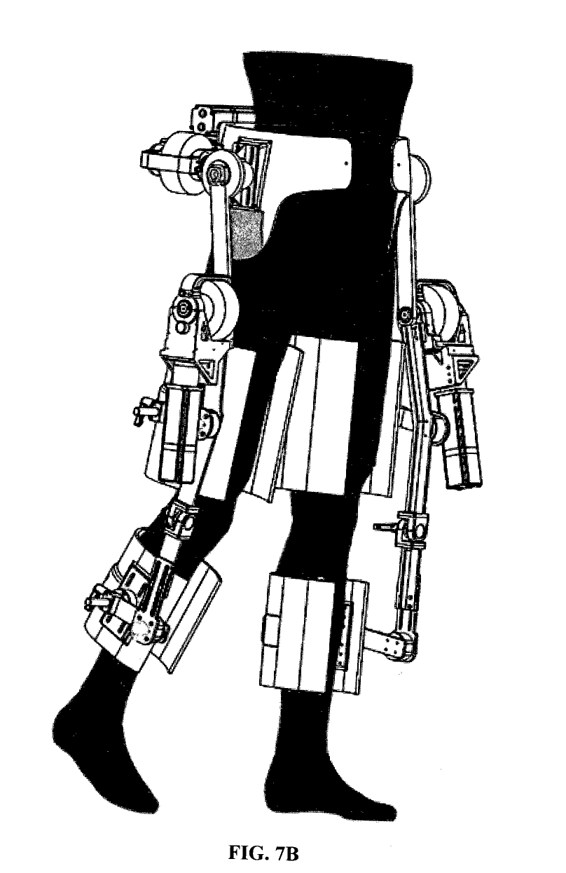

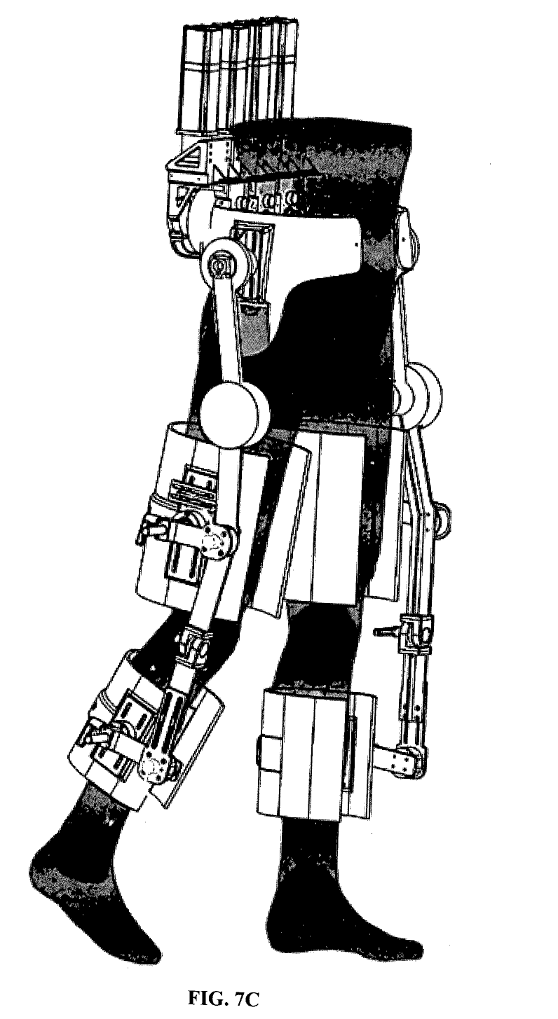

FIGS. 7A to 7C are views illustrating alternative configurations for actuators placement, according to the present invention.

The present invention will hereinafter be described in detail, making reference to the above-indicated figures.

In particular, a robotic device 1 according to the present invention is shown in FIG. 1.

The device 1 is a wearable robot for assistance to walking and motor rehabilitation, able to assist flexion/extension motions of hip and knee in the sagittal plane. Moreover, the proposed device may be used as a “human augmentation” instrument and as a device for the monitoring of motion.

The robot is equipped with a planar kinematic structure having two Degrees of Freedom (DoF). Said structure is comprised of a kinematic chain connected in parallel to the lower limbs. The human-robot system, in order to ensure optimum assistance, must assume different configurations compatible with the characteristic range of motion of walking.

The device comprises a pelvis cuff, at which it is realized a first pelvis joint to which a first actuator corresponds, and a second intermediate joint to which a second actuator corresponds. The pelvis cuff is made of flexible material, e.g. of carbon fiber, to allow limb motions in the frontal plane.

The kinematic chain comprises a first connecting segment (link) rotatably connected to the two joints; a second connecting segment is rotatably connected to the intermediate joint.

A thigh segment is rotatably connected to the segment at one of its ends and has the opposite end rotatably connected to a thigh cuff.

A leg segment is rotatably connected to the segment at one of its ends and has the opposite end rotatably connected to a leg cuff.

Preferably, the second segment is comprised of two linear portions stiffly connected in an angle point so to form an angle different from 180°, and the thigh segment is hinged to the second segment at the angle point.

As will be better explained hereinafter, the device provides a plurality of adjusting mechanisms for adaptation to different anthropometric sizes.

The kinematic structure selected for reaching the aims set out above is a non-anthropomorphic structure. Such a type of structure, in fact, ensures a better wearability of the device by the user, as it is not necessary to align robotic joint axes with human joint axes. In anthropomorphic structures, in fact, an imperfect alignment of such axes causes a generation of shear forces, i.e. forces parallel to body segments, at the level of the interfaces between device and limbs; such forces are not useful for assistance to walking and can create sensations of discomfort, or even pain, in the user.

In FIG. 2 there are shown the forces acting on body segments when a subject wears a robotic structure whose kinematics are as those presently described. Of the two components of the interaction forces, only those perpendicular to human segments (Fd) are useful to the ends of assistance to motion. The longitudinal components (Fu), parallel to body segments, correspond to shear forces ineffective to the ends of assistance and harmful, as potentially able to cause traumas to articulations and discomfort to the user following scrapings of connecting cuffs.

A way to ensure that the forces Fu be nil or anyhow negligible with respect to the forces Fd consists in:
connecting the cuffs to robot segments hinged at both ends;
dimensioning the kinematic structure so that during walking said connecting segments (links) keep substantially perpendicular to the body segments to which the related cuff is connected.

From the analysis of all possible topologies of kinematic structures able to independently assist hip and knee joints, it was found that only three of them (see FIGS. 3A, 3B and 3C) can originate specific morphologies satisfying the two constraints reported above (i.e.: cuffs connected to links with hinges at both ends, said links keeping essentially perpendicular to related body segments during the gait cycle).

The three topologies are composed of four links (one of which ternary) and six rotary joints, two of which actuated and four passive. In all three cases, the transfer of forces along perpendicular direction Fd can be ensured, for specific dimensionings, by the presence of the links hinged at both of their ends, which can remain perpendicular to the thigh and to the leg, enabling an optimum transfer of forces of assistance to flexion/extension of hip and knee (Fd equal to zero, and anyhow Fd<<Fu).

According to the preferred embodiment of the present invention, the device realizes a topology of the type shown in FIG. 3A.

The corresponding kinematic chain is shown in FIGS. 4A and 4B.

In these figures, joints A, D are the actuated robotic joints, whereas the other four robotic joints are passive. Links BE, CF are substantially perpendicular to thigh and leg, respectively. Link DEF is the ternary link. The distance between the pelvis joint H and the point of attachment of the robot on the thigh is defined by quantity HB, whereas the distance between the knee joint K and the point of attachment of the robot on the leg is defined by quantity KC.

Each of said thigh and/or leg segments, BE and CF, may comprise a respective elastic portion.

In other words, said segments can be implemented with stiff elements (hinged rods) or flexible elements (flexible rods or rods supported at their ends by elastic hinges), as schematically shown in FIG. 4B.

In Table 1, there are indicated the values of the lengths of the various robotic links for the device according to the preferred embodiment of the present invention.

TABLE 1

| | Segments | | | | | |
|---|---|---|---|---|---|---|
| | AD | DE | EF | EDF | BE | CF |
| | [mm] | [mm] | [mm] | [Degrees] | [mm] | [mm] |
| Dimensions | 218.5 | 184.5 | 316.5 to | 10 | 81 | 100 |
| | | | 381.5 | | | |

Of course, the above-indicated preferred dimensions are not to be considered as essential.

In particular, the first linear portion DE has a length of about 135-235 mm.

The second linear portion EF has a length of about 300-400 mm.

The angle EDF is about 1° to about 30°, therefore, in the angle point, the two linear portions could form an angle of about 120° to about 180°.

The thigh segment BE has a length of about 30 to 130 mm.

The leg segment CF has a length of about 50 to 150 mm.

The device is able to adapt to users of different build (in a height range of 160 to 190 cm). This is made possible by the presence of at least three possible adjustments, as shown in FIGS. 5A to 5D.

FIG. 5A shows a first mechanism for adjusting the position of the robotic joints on the cuffs, by means of slots. Such an adjusting mechanism may advantageously be provided for all three cuffs of the device.

FIG. 5B shows a mechanism for adjusting the length of link DEF, by means of slots, and a mechanism for angular adjustment of the links in the frontal plane.

FIG. 5C shows a mechanism for adjusting the distance of the robot from the human body in the frontal plane, at the level of the pelvis cuff.

FIG. 5D shows a second mechanism for adjusting the distance of the robot from the human body in the frontal plane, present at the level of the thigh cuff. Such a mechanism for adjusting the distance of the robot from the human body in the frontal plane is also present at the level of the leg cuff.

Advantageously, the robot may be equipped with mechanical stops, present on the thigh cuff and shown in FIG. 5D, able to prevent knee joint hyperextension and therefore possible traumas for the user.

The device according to the present invention comprises, for each leg, two actuators assembled so as to actuate respectively joint A of FIG. 4 and joint D of FIG. 4. Moreover, a means for controlling and driving the actuators is provided.

As seen in FIG. 1, in this configuration the actuators are all arranged at the level of the user's pelvis and trunk, so to reduce inertial effects due to swinging masses during walking.

According to the preferred embodiment of the present invention, the actuators are gearmotors with an elastic element in series interposed between the reduction mechanism and the load.

A depiction of an actuator suitable to be employed in the present invention is reported in FIG. 6.

In particular, for each actuator, an electric motor 1 (e.g., brushless DC) is placed parallelly to segment AD of FIG. 4. A reduction system preferably comprises a planetary reduction gear 2 and a conical or hypoid gear 6; the latter transfers motion from an axis lying in the sagittal plane to one parallel to the human joints to be actuated.

Said dual stage may be realized so to have a >50% kinematic efficiency, so to allow a suitable retrograde motion, enabling a moving from the outside, even when the motors are not powered on, and intrinsically improving robot safety (the subject, in fact, is able to move the robot by moving his/her legs: the robot is not perceived as a stiff device).

Downstream of the hypoid reduction gear a torsion spring 7 is present, designed so to withstand a maximum torque greater than the maximum torque delivered by the gearmotor. It comprises two torsionally compliant elements, designed by implementing a lamellar geometry, and arranged in a series configuration.

The means for controlling and driving the actuators comprises sensors for detecting the angular position of the actuators.

In particular, said sensors comprise three encoders: one encoder (e.g. a resolution of about 0.04 degrees) measuring the drive shaft rotation to the ends of current commutation on windings; two encoders 10, of incremental or absolute type (e.g., a resolution of about 0.01 degrees) measuring the rotations upstream and downstream of the torsion spring. The two absolute encoders are connected to the spring by cylindrical gears, e.g. with a 0.2 module, acting as multipliers (e.g., 2:1) for rotations acquired by the encoders.

Said sensors allow to measure the deformation of the elastic element mounted in each actuator. Said deformation, multiplied by the stiffness of the same elastic elements, gives a measurement of the torque applied to the corresponding actuated robotic joint. The same torque value may be used as feedback signal for torque control of the actuator.

The cuffs interfacing with body segments are present at the level of the pelvis, thigh and leg, as schematically shown in FIG. 1.

The pelvis cuff, representing the human-robot interface at the level of the pelvis, is at least partially compliant so as to allow leg motions outside of the sagittal plane, thereby preventing possible traumas or discomfort for the user during walking.

The thigh and leg cuffs enable the transfer of forces from the device to the user. Such cuffs, e.g. made of carbon fibers or polymer material, must be sufficiently flexible to allow wearability, and concomitantly with a stiffness such as to transmit the required forces for assistance to the subject. On such cuffs, a mechanism for connection to the rotary joints of the robot is present. The cuffs may be realized in different sizes, so as to be wearable by users of different build.

FIGS. 7A to 7C show other possible configurations of the robot.

In these examples there are shown three different arrangements of the four actuators required for actuating the four total degrees of freedom of the structure (flexion/extension of the two hip joints and the two knee joints).

In FIG. 7A, the motors which actuate the pelvis joints have been placed vertically on the back of the pelvis cuff; motion is transferred from the actuator output to the pelvis joint by a system of synchronous belts/pulleys. The two actuators which instead actuate the intermediate joints are placed on the thigh cuff.

In FIG. 7B, the motors which actuate the pelvis joints have been placed horizontally on the back of the pelvis cuff; motion is transferred from the actuator output to the pelvis joint by a (conical or hypoid) gear mechanism or by a lead screw system. The two actuators which instead actuate the intermediate joints are placed on the thigh cuff.

In FIG. 7C, the motors which actuate the joints (both pelvis and intermediate ones) have all been placed vertically on the back of the pelvis cuff; motion is transferred from the actuator output to the joints by a cable system.

The actuators' architecture, composed of a gearmotor with a compliant element in series, entails numerous advantages, among which: i) intrinsic compliance, ensured by the torsion spring, for greater safety in coupling between motors and human body; ii) capability to absorb shocks due to heel impact with the ground during walking; iii) possibility of measuring the delivered torque on the basis of the spring deflection reading, without the use of further sensors, with entails reduction of complexity and overall weight; iv) improvement of stability and reliability of the torque controller; v) reduction of actuators' friction and non-linearity.

Assistance is provided by controlling the actuator with an appropriate control, e.g. of impedance, or by generating viscoelastic torques with variable stiffness and damping values. This solution allows to make the system compliant to the subject's action, avoiding to stiffly move his/her limbs.

The market of devices for gait assistance and rehabilitation is continuously expanding. The applications of such devices relate to the clinical fields of assistance and rehabilitation where such devices can be exploited in order to ensure the restoring of a physiological walking in people with motor problems. Possible users of such devices are people exhibiting a physiological decay of motor performances due to aging, people who, following a certain pathology, do not exhibit a physiological walking, or, again, paraplegic people stuck in a wheelchair.

In fact, World Health Organization (WHO) statistical data demonstrate that the aging of average population is constantly on the rise. In 2000, >65-year old aged people in Europe were about 60 millions (16.4% of the European population).

These numbers are destined to grow, and by 2050 an increase in aged population of up to 37% of the Entire European population is foreseen. The physiological decay of motor performances, especially gait-related ones, of aged persons can of course require the use of such devices.

Moreover, according to WHO analyses, 15 million people per year suffer from stroke. Of those, 5 millions remain permanently disabled. In Europe, each year about 450,000 people undergo an ictus and need a rehabilitation motor therapy; in Europe, more than 2,000 clinical centers provide neurorehabilitation therapies for this type of patient.

Finally, in the U.S. and in Europe there are about 500,000 SCI (Spinal Cord Injured) patients who are considered paraplegic, and about 20,000 new SCI patients per year.

The potential market of this patent comprises the use of these devices in rehabilitation centers, or the use of the device by the individual user as a walking aid.

In the case of rehabilitation centers, this device can increase the effectiveness of post-stroke rehabilitative therapies, improving patient's participation and involvement. The number of daily therapies and therefore the total cost of the services that can be supplied by such centers might decrease, as the number of therapists involved and the duration of the rehabilitative session would be reduced.

In case of paraplegic users, the advantages offered by a device that might bring such persons back to walking are countless. The advantage for said users, of being able to carry out normal daily activities without being forced to live on a wheelchair, is enormous. This type of devices can replace manual and motorized wheelchairs; actually, the wheelchair market in 2011 was estimated to be at about US$ 3 billion, and reaching US$ 7 billion in 2018.

Devices of this kind have also been widely exploited to increase motor performances of specific categories of healthy users, such as soldiers on a mission, or those who have the need to carry big loads over long distances.

The present invention has hereto been described with reference to preferred embodiments thereof. It is understood that each one of the technical solutions implemented in the preferred embodiments described herein by way of example could advantageously be differently combined with each other to give shape to other embodiments, falling within the concept of the same invention, and all however comprised within the protective scope of the claims hereinafter.

1. Non-anthropomorphic exoskeletal robotic device for assistance and/or rehabilitation of lower limbs of a subject, comprising a pelvis cuff, wearable by said subject at his/her pelvis; and, for each limb, a kinematic chain comprising:
a first segment hinged to said pelvis cuff at one of its ends so to realize a pelvis joint, and having the opposite end hinged at an end of a second segment so to realize an intermediate joint;
a thigh segment having an end rotatably connected to said second segment and the opposite end rotatably connected to a thigh cuff; and
a leg segment having an end rotatably connected to said second segment and the opposite end rotatably connected to a leg cuff, the arrangement being such that said thigh and leg segments are substantially orthogonal to the corresponding limbs segments during operation of the device, the device further comprising, for each of said kinematic chains, a first actuator of said pelvis joint and a second actuator of said intermediate joint.

2. Device according to claim 1, further comprising means for controlling and driving said actuators.

3. Device according to claim 1, further comprising a plurality of adjusting mechanisms of said segments.

4. Device according to claim 1, wherein each of said actuators comprises a reduction mechanism and an elastic element connected in series with said reduction mechanism.

5. Device according to claim 2, wherein said means for controlling and driving comprises sensors for detecting an angular position of said actuators.

6. Device according to claim 1, wherein said first and second actuators are placed substantially at the pelvis, made integral with a lateral portion of said pelvis cuff.

7. Device according to claim 1, wherein one or more of said actuators is placed substantially at the pelvis, connected with a rear portion of said pelvis cuff.

8. Device according to claim 1, wherein said thigh segment and/or said leg segment comprises an elastic portion.

9. Device according to claim 1, wherein said first segment has a length of about 165 mm to 170 mm.

10. Device according to claim 1, wherein said second segment comprises two linear portions stiffly connected in an angle point so to form an angle different from 180°.

11. Device according to claim 10, wherein said thigh segment is hinged to said second segment at said angle point.

12. Device according to claim 10, wherein a first portion of said two linear portions has a length of about 135-235 mm.

13. Device according to claim 10, wherein a second portion of said two linear portions has a length of about 300-400 mm.

14. Device according to claim 10, wherein said angle is about 120° to about 180°.

15. Device according to claim 10, wherein said thigh segment has a length of about 30 to 130 mm.

16. Device according to claim 10, wherein said leg segment has a length of about 50 to 150 mm.
